(19) United States
(12) Patent Application Publication
(10) Pub. No.: US 2002/0087740 A1
(43) Pub. Date: Jul. 4, 2002

(54) System and method for service specific notification

(76) Inventors: Rick Castanho, Nashua, NH (US); Jeffrey Delaney, Hudson, NH (US); William Harry Kirtley, Arlington, MA (US); Robert Kuszewski, Arlington, MA (US); Robert Matthews, Somerville, MA (US); David A. Page, Manchester, MA (US); Gregory Charles Warden, Belmont, MA (US)

Correspondence Address: CESARI AND MCKENNA, LLP, 88 BLACK FALCON AVENUE, BOSTON, MA, 02210, US

(21) Appl. No.: 10/007,461

(22) Filed: Nov. 5, 2001

Related U.S. Application Data
(60) Provisional application No. 60/246,140, filed on Nov. 6, 2000.

(51) Int. Cl. G06F 9/46

(52) U.S. Cl. 709/318

(57) ABSTRACT

A flexible, programmable messaging system and method for associating specific happenings with particular services and users associated with those services is disclosed. The contact means for the users are held in a single database with retrievable historical information regarding the user and/or the service. Users and administrators are defined where the user may exercise a group of predetermine privileges. Users may subscribe and un-subscribe to one or more services. The administrator may exercise more privileges or all the privileges, and the additional privileges will include creating messages related to specific happenings, editing of the billing for the service, editing subscription forms, managing the members of a service and tracking the delivery of message. The presentation pages and the messaging format are arranged using templates with predetermined information and formats that may be programmable. The system is arranged in a client/server arrangement where standard servers can be used. The users administrators, and messaging systems include virtually all forms of communications.

### CROSS-REFERENCE TO RELATED APPLICATIONS

The present application claims the benefit of U.S. Provisional Patent Application Ser. No. 60/246,140, which was filed on Nov. 6, 2000, of common inventorship and title and which provisional application is hereby incorporated herein by reference.

### BACKGROUND OF THE INVENTION

1. Field of the Invention

The present invention relates to sending messages to selected recipients, and more particularly to predefining triggering happenings and programming the form, content, the time of sending, the delivery method and other such specifics by sender and/or the recipient.

2. Background Information

Today's technology allows people to communicate with each other using a broad array of communications services. The old telephone networks, facsimile, automatic call distribution systems, the Internet, and wireless technologies (pagers, PDA'S, cell phones, etc.) provide the user with many reasonably flexible options for communication services. With respect to the Internet, the typical Internet web service allows a user to subscribe to the service using a single email address. Message delivery services utilize e-mail lists to communicate with subscribers. One limitation with this model is that the recipient is limited to “how” they want to receive information. The recipient does not specify “when” to receive information.

Another limitation that arises due to the myriad of communication services is that any particular recipient may be temporarily most conveniently reached by only one or two of the many ways. Therefore the expansion of the communications techniques, not withstanding options like call forwarding and recording, risks non-delivery or long waiting periods before the designated recipient receives the message.

There is a continuing need to address these limitations by allowing users to create expansive and flexible profiles and rules linking notification events to people and devices.

### SUMMARY OF THE INVENTION

The present invention addresses the above limitations and problems of known is systems. First, users can subscribe to notification events via any device type (phone, fax, email, pager, SMS (Short Message Service), WAP (Wireless Application Protocol), PDA or other wireless device). This empowers the user to prioritize and specify “how” to receive a notification. In addition, the present invention provides an extensive and flexible scheduling feature allowing the user to specify “who” and “when” (and where if not contained in the “how”) to receive each notification. Recipient are those designated to receive the messages or notifications, and recipients may be users, administrators or third parties. For example, third parties may be government or regulatory agencies and/or officals, and similar types of organizations and/or officials.

The present invention with the advantages of specifying “how” and “when” to receive many different types of information enhances the traditional Internet service subscription type applications. As an example, with the present invention recipients can now choose to receive critical information at work Monday through Friday between the hours of 9:00 AM and 5:00 PM. In addition, recipients can create scheduling profiles to indude times the recipients are commuting, at home, asleep, and traveling.

One aspect of the present invention allows senders to predefine happenings such as market corrections, virus alerts, imminent power outages or flight cancellations, etc., while allowing recipients (customers, partners, suppliers and employees) to create their own profiles specifying the preferred contact method, receiving device and timing for each type of happening to which they want to subscribe. This combination of sender and recipient finctionality means organizations can integrate communications with business processes, thereby automating critical communications and saving both time and money. User recipients can create and maintain a personal profile detailing the happenings to which they want to subscribe and be notified, the device by which they would like to be contacted, and any specifications they may have about timing requirements.

An advantage of the present invention is that it enables message senders to predefine recurring happenings and empowers user recipients to maintain and automate their own contact information, communications. By programmatically matching appropriate recipients with happenings, time, money and effort normally spent updating distribution lists and getting the word out is saved, freeing personnel to focus on business. Recipients receive only the meaningful notifications, quickly, and in their preferred manner.

### BRIEF DESCRIPTION OF THE DRAWINGS

The invention description below refers to the accompanying drawings, of which:

FIG. 1 is a flow chart incorporating the present invention;

FIG. 2 is a second flow chart extending that of FIG. 1; and

FIG. 3 is a block diagram/flow chart of an embodiment of the present invention.

### DETAILED DESCRIPTION OF AN ILLUSTRATIVE EMBODIMENT

U.S. Pat. No. 09/496,170, filed on Feb. 1, 2000 and entitled Multi-Mode Message Routing and Management (the entire disclosure of which is hereby incorporated by reference) discloses, inter alia, a delivery system for transmitting messages to a selected single or multiple recipients by means of one or more communication means and/or devices. Such a delivery system is used, in a preferred embodiment of the present invention to be the delivery system for the messages being sent. Such communication modalities may include, for example, conventional or wireless telephone and telephone systems, facsimile transmission, pager, e-mail and Internet, SMS, WAP, and PDA. The present invention in a preferred embodiment may be configured to respond to a variety of rules that specify conditions under which different delivery means and devices may be employed. For example, the rules may specify that if there is no response the message is re-sent or an e-mailed question may be sent within an hour, or the recipient is to be telephoned. Moreover, in addition to alternative transmission means, the rules may specify alternative recipients (as well as alternative modalities for those recipients). The escalation rules may also specify default contact methods, which may apply to specific individuals or to lists of recipients.

The present invention in different preferred embodiments supports a number of business models. The present invention when practiced on the Internet may be considered, in the Internet Layering Model used to describe the functions particularly on the Internet, to operate at the application layer five. When layers are discussed herein they refer to this model.

Some standard terms used in the present invention can be used with alternative meanings in different business models, but for the purposes of the present invention the following terms are defined as follows:

Customers: contracted individuals or organizations who use the present inventive system to provide one or more “services” for their own customers, who are the service's users.

Services: are particular customized versions of the present inventive system or application, accessible through a web browser and a specific URL. A customer may have more than one service. The present invention is designed to allow customization. For example, branding with a customer's logo. There is a fallback service that contains default values for most customizable parameters, but it is not a functional service accessible to users.

Events: one or more types of messages sent by services which are subscribed to by the users. Event names can be customized (e.g. alerts, notifications) in different services as programmed by the customer.

Users or members: those individuals who have the ability to log in to the service, and who may or may not be “subscribed” to receive events.

“Subscription” is a term that has two subtly different meaning. One such meaning is in reference to billing plans to describe those operations which involve a monetary transaction—e.g. a member of a service may be required to pay a sum of money by credit card to subscribe to the service; this is a “subscription” billing plan, a plan in which the user pays for access to the service. The second meaning is the “corporate” billing plan—used for customers who control the membership of the service internally, and who typically pay periodically for message volume.

However, there is also a generic sense of “subscription”—the process by which members of all services select events to receive. Becoming a member of a service by any means (sign-up or creation by an administrator of the service)—or even the monetary transaction described above, although it may be a necessary precursor—does not mean that a user has actually selected events to receive. When a user of any billing plan in any plan selects an event, the user is said to be generically “subscribed” to that event. Regardless of billing status, a user may not be considered to be “subscribed” until the user has selected at least one event to receive.

Privileges: authorizations to perform one or more of a group of operations.

The specific operations include operations that may be specific to customers. A non-exhaustive list of privileges includes:

Log in to the service

Create a member (create an account for a new user)

Delete a member (remove his account from the service)

Enable/disable members (temporarily suspend log-in and subscription rights)

Edit a member (modify a user's account information)

Create an event (define and launch an alert/notification)

Track deliveries (access records of prior events)

Assign privileges to members

Administrators: Typically personnel of a customer that has authorization to more privileges than a user (see below). A master administrator has authorization to perform all the privileges. The use of administrators provides customers with “administrative” features—the ability to create users in various ways, edit the account and subscription information of the members, create and launch events, and review the history of prior events. A “master administrator” is one who is authorized to exercise all the privileges available.

Role: An aggregation of certain authorized privileges vested in a user. A user may have more than one role. Privileges are checked to determine what operations a user is allowed to perform, and also what pages are presented to that user and what elements that user sees in menus.

Every individual who creates an account (or for whom an account is created) is assigned a role as a “user.” A user has the ability to log in to the service for which his account was created, to modify his password and security question, to subscribe to the events of that service, to edit and save his contact information, and to define schedules which establish which events will be delivered to which contact devices at what times.

Any role that embodies privileges greater than this is considered an administrator's role. When a service is created, two roles are typically created with it—user and master administrator. The master administrator may be assigned to one or more individuals. In some instances the customer may want the administrator to be a third party.

Other administrators are created and defined by the customer by aggregating the appropriate privileges into a role entity that can be assigned to users (in addition to the “user” role). Examples of roles might be “member administrator” with the ability to create and delete members, edit member account information, and enable/disable members—or “event administrator”—the authority to create and launch an event, and to view the historical records of events for that service.

Administrators who have the privilege of assigning privileges may bestow the privileges they themselves have upon other individuals. This structure of roles and privileges, combined with the functionality of the present invention keyed to such roles and privileges, makes it possible for customers to administer their own services to manage situations which relate to changing personnel or modification of membership, and to respond promptly to the concerns or questions of the users of their service.

The structure and operations described above is basic. However, the present invention is conceived and structured for the ability to handle more complex models. An example, for instance:

A “multi-service” portal, in which a variety of notification services—e.g. community or state government, travel, hobby groups, topical news headline service—are available for new members to subscribe to. Members of the XYZ service could subscribe or unsubscribe at will to the various secondary services, and financial transactions would be routinely handled as part of this operation. Any change in contact information would automatically affect all subscriptions with no effort on the part of the member, and the member would further be able to change the way in which the member received each notification.

The feature of the present invention that makes the above possible is called a “context.” Whenever an individual becomes a user of a service, the user is given a “context” in a database related to that service. A user is allowed to log in to the service only if the user has a context for, i.e. is a subscribed member of, that service. A user, then, can have a single account but multiple contexts and be a member of multiple services. This approach provides the user with the advantage to maintain a single central record of the user's contact information. In the example above, for instance, the user could have a context for the XYZ service, allowing him to log in to the XYZ site, and also have contexts for, for example, a news service's Headline Notifications, Bargain Flight Alerts, and, say, the Local Power Company alerts.

When an administrator of a service “deletes” a member, the member is not in fact removed from the database—the member's context for that service is deleted. The member is no longer a member of that service, and cannot log in, but his basic account, contact information, and memberships in other services are unaffected.

Templates:

Templates allow the customer to modify the look, functionality and voice messages of their custom service. There are two types of templates: user interface (IU) templates, and message delivery (MD) templates.

The UI templates are web pages that are customizable by the customer for specific customer needs. The inventive application uses many web pages to allow users to enter data, navigate the application and receive notifications. While the basic functionality of these pages does not change, many of the details of the pages can be modified to meet the customer's needs.

UI templates are designed to allow for the modification of one or more of the following non-exhaustive list of graphical elements:

Text Color

Background Color

Text Size and Style

Page Design Elements

Logos and links to other customer web pages

In addition a customer can request the form and substance of the text on the web pages.

UI templates also allow the customer to provide specific information. Some examples are:

Adding pre-defined lists of options such as a list of airports or months.

Adding pre-populated text boxes such as entering today's date in a form by default.

Adding the ability to provide customer specific information such as flight numbers, account numbers or sales person's name.

MD templates provide customers with means for delivering customized messages or notifications. Each customer might have unique templates for sending fax, email, SMS, or voice messages. Message templates retrieve the information provided in the UI templates to create a personalized message. Modifications to MD templates include, among others, voice recordings, graphics, text or content changes. Moreover MD templates may be used to create a proprietary look and feel and to conform to their standard corporate communication and branding requirements.

In some preferred embodiments the ability to modify such templates may be vested with the present invention owner/developer, but in other preferred embodiment customers and or other third parties may be so authorized.

Some examples of customizations include:

Adding a company logo to a fax or a fax cover page.

Adding custom information, such as account numbers or overdue balances to a fax, email, sms or voice messages.

Making custom layout changes to a fax to give the appearance of a form

Adding links to customer websites in emails

Recording professional voice prompts for messages delivered over the phone.

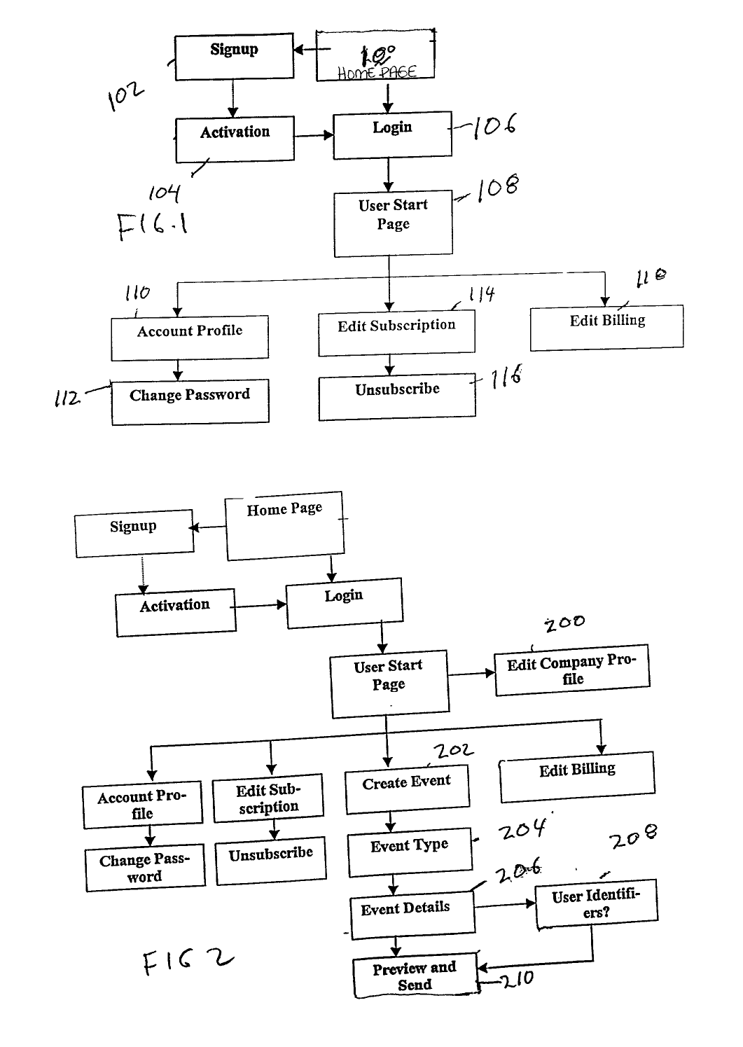

FIG. 1 shows flow of activities that a user would use when communicating with the inventive system. The user accesses the Home Page 100 as typically accomplished over the Internet. Users register 102 an identity with the application. Once a user signs up, the login name provided during the registration can be used to subscribe to multiple services across multiple portals.

Users must establish a unique login name and password along with other additional required fields in order to complete the signup process. Once the signup process is complete, an email is immediately delivered to the user containing an activation link.

A newly created member is created as “inactive” and can only be activated by responding the to URL sent in the activation email. Clicking on the URL will force the user to enter their username and password to activate 104 their account.

Once the account is activated, users can login 106 by providing their login name and password at the login screen. A user start page 108 is then presented to the user.

From the user start page, the user can access the Account Profile page 110 that allows the user to edit the users own profile and specifically enter their contact information. Specific contact information entries are required to subscribe to events provided by the inventive system. The only required contact information entry is the Work Email address. All other contact information is optional. Within the Account Profile page is the link 112 for changing the password. The user must type in the original and enter the new password.

Before a user can begin receiving messages from a service, the user must first subscribe to that service. A user signing up and establishing a unique login “name” does not automatically subscribe that user to a service. The user start page 108 lists service(s) available to the user for subscribing. In a single service portal, there will always be only one service available, whereas in a multi-service portal there are many services available for subscription. Each service may require additional information to complete the subscription process. For example, an airline service may require the user to enter their frequent flyer number. Also many services will require a billing plan be established before the subscription is completed.

Once the user has subscribed to a service, the next step is to select events provided by that service 114. For example, an airline service would typically provide the events (1) Cancelled Flight, (2) Delayed Flight, and (3) Gate Change. The user selects an event by specifying how they want to be contacted per event. A check box for each contact method is listed next to each service event.

Within the service subscription page 114, a link allows the user to unsubscribe 116 to that service. Unsubscribing first gives the user the opportunity to confirm the selection. Once confirmed, the user is unsubscribed to the service.

Each service can be configured to require the user to setup a special billing plan 118. For example, one plan might require the user to setup a subscription based credit card billing plan with a $100 a year fee. Other services may provide the service for free to the users and pick up the costs on the back end. If a billing plan is required, it is presented to the user during the service subscription.

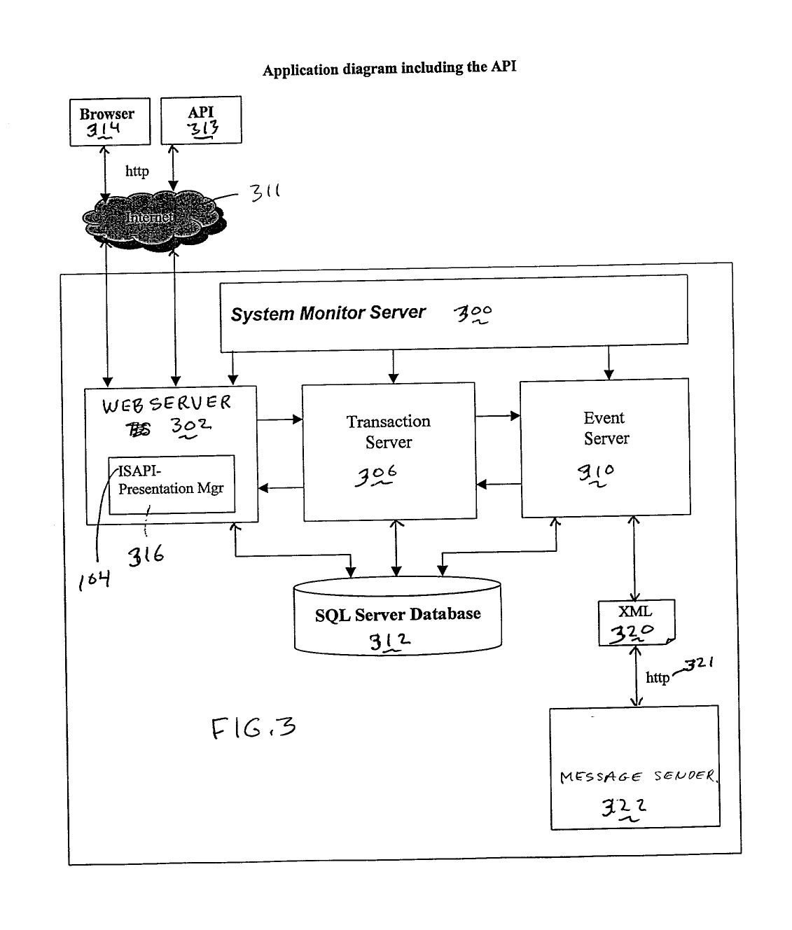

FIG. 2 shows the flow of activities that an administrator would use when communicating with the inventive system. The experience is the same as for a user except that an administrator has the additional privileges to Edit Company profile, Create Events. In addition the administrator has the authorization to manage the service members, and to track the delivery progress of each message delivery.

The Edit Company Profile 200 allows the administrator to edit and change basic company information.

Events are notifications that the service administrator creates to alert the subscribed members. For an airline, the events are triggered by happenings as indicated, e.g. “Cancelled flight,” “Delayed flight,” etc. The Create Event 202 features offers a “wizard-like” (a known term in the art) flow for creating the event.

Event Type, 204 allows the administrator to select the happening and event type. The event types are pre-determined by the inventive system when the service is created.

The Event Details 206 screen contains the common and specific details for a given event. The common event fields include the Subject, Sender name, return email, fax number, and pager callback number. The contact information specific fields are derived by default from the company profile.

User Identifiers 208 targets specific members in addition to their general subscription membership to receive an event. For example, a United Airlines service could have thousands of subscribers for the Cancelled flight event. However, when this event is triggered, the Administrator clearly does not want to notify all subscribers for this event, but rather only those that are effected by it (i.e. on that plane). The service does this through a features called User Identifiers 208. This feature allows an Administrator the option of providing a list of user identifiers affected by this event.

Preview and Send 210, the final page, is the Preview and Send page. This page summarizes the above selection processes. Pressing Send from this page submits the event to the-subscribed users.

After the administrator presses send, the inventive system returns to the user “Your message is being sent page.” During this time the inventive system queries the database to find all members who have subscribed to the service event being triggered (taking into consideration the optional user identifiers). Based on this information, the appropriate XML request document is dynamically created and handed to the delivery system is as described above, in a preferred embodiment, as a set of one time contacts for message delivery.

A preferred practical embodiment of the present invention is shown in FIG. 3. The system is a multi-tier application deployed as a collection of Windows NT (registered and use trademarks of Microsoft Corp.) services. All of the services are deployed on multiple Windows NT servers. This embodiment is extensible in that new servers can be deployed at any time in order to increase the system's capacity. The service includes Transaction Servers 306, Event Servers 310, and a System Monitoring Server 300. In addition, Microsoft SQL Server 312 as a data repository as well as Microsoft IIS (Microsoft trademarks) server as the Web Server 302.

The application's Web Server/Presentation module 304, 316 manage the visual presentation to the user's browser 314, typically a graphical user interface (GUI). Users may interact with the inventive application via a standard web browser to sign up and subscribe to a service.

Using a browser, an administrator or user may request a page or a transaction via a hyperlink or page form submission, as is commonly used in the art via the Internet 311. This action invokes a request to the web server 302. This request is intercepted by communicating with the web server 302. Control is passed to an in-process module called the ISAPI (Internet Server Application Program Interface) 316 which accepts the inbound request. ISAPI is an interface designed by and available through Microsoft Corp. to interface with Microsoft's IIS web server.

The ISAPI 304 validates the request by extracting the session ID (identification) from the request and looking up in a database in order to validate it. Once the session is established or validated, ISAPI submits the request to the Transaction Server 606. A session ID is commonly used on the Internet to represent a logged in user. The session is a character string created by the service to uniquely identify the user for a limited period of time.

When the transaction server 306 completes the transaction, the final step and responsibility of the ISAPI layer is to render the outbound page. This is accomplished by using the Presentation Manager 316. The Presentation Manager is a rendering engine that dynamically formats a web page based on data returned from the Transaction server along with a specified template. The rendered page is returned back to the browser as standard HTML.

The transaction server 306 is an NT service that implements the primary business logic of the application. All requests submitted to the web servers are distributed to one of the running transaction servers. The transaction server determines the type of request submitted by the user, processes the request, and returns the requisite data back to the web server's presentation manager.

The transaction server receives a request from the web server. All of the data forming the request is unbundled by the transaction server. Since the transaction server implements many different transaction requests, the first task is to determine the type of transaction requested. This is done by reading the transaction type variable submitted by the user. Examples of transactions include Login, Change Password, Signup, Save Contact Information, etc.

Once the type of transaction is determined, the transaction server carries out the necessary business logic for that transaction. Typically this involves interacting with the database 312 to select, insert, or update necessary information for this transaction.

After the business logic is complete, the transaction server collects the necessary data to render a return page. This information is passed back to the web servers presentation manager for final HTML rendering for delivery to the users interface.

The Event Server 310 is an NT service that implements all of the profiling logic and message delivery logic for the application. Requests for delivery are transformed into the proper XML form as documented by the XML based API (Application Programmer Interface).

From an application viewpoint and as discussed above, the term “event” is a pre determined entity or happening to which users “subscribe.” Events may be custom for each application. Examples of events include: “Flight Cancellation,” “Virus Alert,” etc. Users subscribe to events while Administrators determine and define happenings that, when they occur, trigger the messages being sent. When an Administrator triggers an event via browser, the Transaction Server 306 collects all of the data for that event and submits the event to the Event Server 310 for processing.

An API 313 is also available to access the inventive system via the Internet 311 to enable an automatic event sending that does not require an administrator physically to access the system. In such a case the customer would create an application that receives information from the client's internal system. For example, when a flight is canceled by an airline, the airline's internal system, that receives the actual cancellation notice, sends a predetermined XML document with the particular information to the inventive system that triggers the event. The system then looks up the list or recipients and contact information and has the message sent. An administrator need not be involved. In a more typical scenario the administrator via a browser physically enters that the happening occurred which triggers the message sending process.

The Event Server has four main functions when processing an event: (1) deter30 mine who, how, and when each user has subscribed to the event, (2) filter the list of recipients based on schedules (3) generate an XML 120 document representing the targeted deliveries, and (4) send the XML document to a delivery system 122 to carry out the actual delivery.

The Event Server 310 utilizes its internal rules engine to determine who has subscribed to the target event. It does this by querying the database of subscribers. Once the list of event subscribers is determined, the Event Server then determines how and when each subscriber has chosen to receive this event. The “how” is based on the configured devices the user wishes to receive the event. The “when” is based on the configured schedules the user has configured to receive the event.

The final list of subscribers and devices is then turned into an in-memory XML document representing each event subscriber along with his associated device configuration for that event. The XML document is then submitted to the delivery system via HTTP.

In order to communicate with the delivery system, the Event Server 310 first initiates an HTTP connection 321. Once the HTTP connection is established, the XML 120 document is submitted to the delivery system 322 for processing. After submitting the request, the Event Server waits for the response from the delivery system. The response is also an XML document representing the success or failure of the submitted request. The Event Server extracts the necessary status from the returned XML document and updates the SQL database 312.

The System Monitoring Server 300 is a single instance NT (Microsoft Corp. trademark) server that controls all monitoring aspects of the application. It is the responsibility of the system monitoring service to start and stop all services, distributes runtime data changes to the application services, and to constantly monitor the status of all running services.

The System Monitoring Service 300 distributes runtime data to all the services dynamically. This includes information such as server pools, various system quotas, etc. In addition this service assures that all services are continuing to function normally by querying the status of each service frequently. If the system monitoring service recognizes that a service is not responding, it immediately removes that service from the available pool of services until it can establish a successful reconnection to that service.

A series of application modules, as shown in FIG. 3, are referenced, in some above, and are described as follows:

The user launches his browser and navigates to the home page for the present inventive application, e.g. http://www.inventivesystem.com/<application>. Using the HTML form, the user enters his Login name and password and presses the Login button. This action causes the browser to execute an HTTPS form request. The request includes the login name, password, and transaction type. This information is sent via HTTPS to the IIS web server.

The Web Server 302 immediately passes control to the ISAPI plugin. The ISAPI takes the request and sends it to one of the established Transaction servers.

The Transaction Server 106 reads in the request data and determines that this is a request for the Login transaction. Next the business logic for the login transaction is executed. This involves validating the login credentials against the member database. Once the business logic has been executed, the transaction server queries the database for the necessary data that is required for the subsequent page. This information along with a template page name is passed back to the ISAPI/Presentation Manager.

The Presentation Manager 316 receives the data and template returned from the transaction server and creates a rendered HTML page. This page is then returned back to the user via HTPPS.

The following describes the application flow example of an Administrator triggering an event. In this example, the ‘Flight Delay’ is used as an example.

Browser Form Submission

The administrator launches his browser and navigates to the home page 100 of FIG. 1 for the inventive system application: Using the HTML form, the user enters his Login name and password and presses the Login button, an object as known in the art. Through a series of page navigation and form submissions (described above), the administrator triggers a Flight Delay event.

ISAPI Request

With respect to FIG. 3, the Web Server 302 immediately passes control to the ISAPI plugin 304(a term of art) and the ISAPI layer takes the request and sends it to one of the established Transaction Servers.

Transaction Server Processing

The Transaction Server 306 reads in the request data and determines that this is a request for the Create event transaction. Next the Transaction Server gathers the necessary information from the request and notifies the Event Server to process the event. The Event Server begins to process the event in parallel with the ISAPI response.

ISAPI Response

The Presentation Manager 116 receives the data and template returned from the transaction server and creates a rendered HTML page. This page is then returned back to the user via HTTPS.

Event Server Processing

The Event Server 310 receives the information regarding the triggered event (Ex. ‘Flight Delay’). The Event Server then queries the database to determine all of the subscribers to the event. Next all of the subscribers' schedules are referenced to determine how and when each person should contacted. From this list, the Event Server generates the proper XML representing the list of targeted deliveries.

The Event Server then opens up an HTTP connection and submits the XML request to the Message Deliver 322. Once the response is returned, the Event Server updates the local database with the return status.

What is claimed is:

1. A method for service specific notification comprising the steps of:
defining at least one service,
defining happenings related to each service,
listing recipients, recipients defined as users or other parties designated to receive messages,
associating the recipients with each services,
defining and associating contact information with each of the recipients,
composing specific messages for one or more of the recipients in response to one or more of the happenings occurring, and
in response to the occurrence of a happening, sending out the associated specific messages to the associated recipients via the contact information.

2. The method as defined in claim 1 further comprising the steps of:
subscribing and un-subscribing a user to one or more services, wherein the unsubscribed user is prohibited from being associated with those services.

3. The method as defined in claim 1 wherein the step of defining and associating contact information includes the steps of associating a message delivery means, device, and scheduled times with the recipients.

4. The method as defined in claim 1 further comprising the step of:
recording of messages delivered, happenings, times, means for delivery and device for delivery of the messages to the recipient.

5. The method as defined in claim 1 further comprising the step of:
determining if the message is not received, and, in response thereto, re-sending the message. and
re-sending the message via different means and to different devices.

6. The method as defined in claim 1 further comprising the step of:
billing for the use of the service.

7. The method as defined in claim 1 further comprising the step of:
defining a set of privileges,
authorizing users one of more of these privileges, and
authorizing an administrator to exercise the privileges of the user and the privileges to create and edit messages, to change the privileges afforded to a user, to manage members of a service, and to track delivery of messages to recipients.

8. The method as defined in claim 7 wherein the set of privileges includes logging in, creating a member, deleting a member, enabling/disabling members, editing a member, creating an event, tracking deliveries, and assigning privileges to members.

9. The method as defined in claim 1 further comprising the step of:
creating a database with a single central record of each user's contact information, wherein the contact information.

10. The method as defined in claim 1 further comprising the step of defining user and administrator interface templates and message delivery templates.

11. The method as defined in claim 10 wherein the step of defining user interface templates comprises the steps of creating and editing the presentation pages' background colors; text colors; text size and fonts; design elements; logos and links; and the substance of the information presented on each presentation page.

12. The method as defined in claim 10 wherein the step of defining the message delivery template comprises the steps of creating and changing the look and feel of the communications to the users and recipients, wherein the look and feel includes a company logo to a facsimile, adding specific customer information, layout appearance elements, links to customer web sites, and recording audio and video as appropriate to the messages.

13. The method as defined in claim 1 further comprising the steps of:
writing an application program resident in a customer's computer system, wherein the application program generates a triggering message to the service,
entering the occurrence of a happening into the customer's computer system, in response, the customer's computing system triggers the service by sending the triggering message with information enabling the service to send out the corresponding specific messages to the listed recipients and users.

14. A service specific notification system comprising:
means for defining at least one services,
a list of happenings related to each service,
a list of recipients, recipients defined as users or other parties designated to receive messages
means for associating the recipients with each service,
contact information associated with each of the recipients,
specific messages associating one or more of the recipients with one or more of the happenings,
in response to the occurrence of a happening, means for sending out the associated specific messages to the associated recipients via the contact information.

15. The system as defined in claim 14 firther comprising:
means for subscribing and un-subscribing a user, wherein the un-subscribed user is prohibited from being associated with those services.

16. The system as defined in claim 14 wherein the contact information comprises means for associating a message delivery means and device with the recipient.

17. The system as defined in claim 14 further comprising:
a record of messages, happenings, time, means for delivery and device for delivery of the message to the recipients.

18. The system as defined in claim 14 further comprising:
means for determining is the message is not received, and, in response thereto, resending the message, and
means for re-sending the message a programmable number of times, and resending the message via different means and to a plurality of devices.

19 The system as defined in claim 14 further comprising:
means for billing for the use of the apparatus.

20. The system as defined in claim 14 further comprising:
a set of privileges, wherein the user is authorized to exercise one of more of these privileges, and
an administrator, wherein the administrator is authorized to exercise the privileges of the user and to create and edit messages, to change the privileges afforded to a user, to manage members of a service, and to track the delivery of messages.

21. The system as defined in claim 20 wherein the privileges include logging in, creating a member, deleting a member, enabling/disabling members, editing a member, creating an event, tracking deliveries, and assigning privileges to members.

22. The system as defined in claim 14 further comprising:
a database with a single central record of each user's contact information, wherein the contact information is related to messages and to the happenings.

23. The system as defined in claim 14 further comprising user interface templates and message delivery templates.

24. The system as defined in claim 23 wherein the user defined templates comprise means for creating and editing the presentation pages' background colors; text colors; text size and fonts; design elements; logos and links; and the substance of the information presented on each presentation page. 25. The system as defined in claim 23 wherein the message delivery template comprises means for creating and changing the look and feel of the communications to the users and recipients, wherein the look and feel includes a company logo to a facsimile, adding specific customer information, layout appearance elements, links to customer web sites, and recording audio and video as appropriate to the messages. 26. The system as defined in claim 14 further comprising:
an application program resident in a customer's computer system, wherein the application program generates a triggering message to the service, an occurrence of a happening, the occurrence entered into the customer's computer system, in response,
means for sending, by the customer's computing system, the triggering message with information enabling the service to send out the corresponding specific messages to the listed recipients and users.
